(19) United States
(12) Patent Application Publication
(10) Pub. No.: US 2021/0333625 A1
(43) Pub. Date: Oct. 28, 2021

(54) LIQUID-CRYSTAL DEVICE AND SUN-GLASSES

(71) Applicant: InnoLux Corporation, Miao-Li County (TW)

(72) Inventors: Chin-Lung TING, Miao-Li County (TW); Chean KEE, Miao-Li County (TW); Bi-Ly LIN, Miao-Li County (TW); Yeong-E CHEN, Miao-Li County (TW)

(21) Appl. No.: 17/215,811

(22) Filed: Mar. 29, 2021

(30) Foreign Application Priority Data
Apr. 28, 2020 (CN) 202010348749.0

(51) Int. Cl. G02F 1/1335; G02C 7/10

(52) U.S. Cl. CPC G02F 1/133526; G02C 7/101; G02F 1/133509

(57) ABSTRACT

A liquid-crystal device including a liquid-crystal module and a driving device is provided. The driving device provides a control signal to the liquid-crystal module to control the transmittance of the liquid-crystal module and includes a substrate, a control circuit, and a photovoltaic device. The control circuit generates the control signal. The photovoltaic device supplies power to the control circuit. The control circuit and the photovoltaic device are located on the substrate.

### CROSS REFERENCE TO RELATED APPLICATIONS

This application claims priority of China Patent Application No. 202010348749.0, filed on Apr. 28, 2020, the entirety of which is incorporated by reference herein.

### BACKGROUND OF THE DISCLOSURE

### Field of the Disclosure

The disclosure relates to a liquid-crystal device, and more particularly to a liquid-crystal device with a photovoltaic device.

### Description of the Related Art

The types and functions of electronic devices have increased as technology has developed. Most portable electronic devices have a rechargeable battery built into them to power the components within the portable electronic devices. Electronic devices fail to work properly when users forget to recharge the rechargeable batteries. Furthermore, in order to receive external power, each electronic device needs multiple charging contacts to connect a charging device. However, water vapor can easily enter the electronic device through the charging contacts.

### BRIEF SUMMARY OF THE DISCLOSURE

In accordance with an embodiment of the disclosure, a liquid-crystal device comprises a liquid-crystal module and a driving device. The driving device provides a control signal to the liquid-crystal module to control transmittance of the liquid-crystal module and comprises a substrate, a control circuit, and a photovoltaic device. The control circuit generates the control signal. The photovoltaic device supplies power to the control circuit. The control circuit and the photovoltaic device are located on the substrate.

In accordance with another embodiment of the disclosure, a pair of sunglasses, comprises a liquid-crystal device and a spectacle frame. The liquid-crystal device comprises a liquid-crystal module and a driving device. The driving device provides a control signal to the liquid-crystal module to control transmittance of the liquid-crystal module and comprises a substrate, a control circuit, and a photovoltaic device. The control circuit generates the control signal. The photovoltaic device supplies power to the control circuit, wherein the control circuit and the photovoltaic device are located on the substrate. The spectacle frame holds the liquid-crystal device.

In accordance with another embodiment of the disclosure, a liquid-crystal device comprises a liquid-crystal module, a control circuit, and a photovoltaic device. The liquid-crystal module comprises a first substrate, a second substrate, and a liquid-crystal layer. The liquid-crystal layer is enclosed between the first substrate and the second substrate. The control circuit controls the transmittance of the liquid-crystal module. The photovoltaic device supplies power to the control circuit. The control circuit is disposed on the first substrate or the second substrate. The photovoltaic device is disposed on the first substrate or the second substrate.

### BRIEF DESCRIPTION OF THE DRAWINGS

The disclosure can be more fully understood by referring to the following detailed description and examples with references made to the accompanying drawings, wherein:

FIG. 1 is a schematic diagram of an exemplary embodiment of a liquid-crystal device according to various aspects of the present disclosure.

FIG. 2A is a top view of an exemplary embodiment of the liquid-crystal device according to various aspects of the present disclosure.

FIG. 2B is a cross-section view of an exemplary embodiment of the liquid-crystal device along the dotted line AA′ in FIG. 2A.

FIG. 2C is a cross-section view of an exemplary embodiment of the liquid-crystal device along the dotted line BB′ in FIG. 2A.

FIG. 3A is a top view of an exemplary embodiment of the liquid-crystal device according to various aspects of the present disclosure.

FIG. 3B is a cross-section view of an exemplary embodiment of the liquid-crystal device along the dotted line CC′ in FIG. 3A.

FIG. 3C is a cross-section view of an exemplary embodiment of the liquid-crystal device along the dotted line DD′ in FIG. 3A.

FIG. 4A is a top view of another exemplary embodiment of the liquid-crystal device according to various aspects of the present disclosure.

FIG. 4B is a cross-section view of an exemplary embodiment of the liquid-crystal device along the dotted line EE′ in FIG. 4A.

FIG. 4C is a cross-section view of an exemplary embodiment of the liquid-crystal device along the dotted line FF′ in FIG. 4A.

FIG. 4D is a cross-section view of another exemplary embodiment of the liquid-crystal device along the dotted line EE′ in FIG. 4A.

FIG. 4E is a cross-section view of another exemplary embodiment of the liquid-crystal device along the dotted line FF′ in FIG. 4A.

FIG. 5A is an application schematic diagram of an exemplary embodiment of the liquid-crystal device according to various aspects of the present disclosure.

FIG. 5B is an application schematic diagram of another exemplary embodiment of the liquid-crystal device according to various aspects of the present disclosure.

FIG. 5C is an application schematic diagram of another exemplary embodiment of the liquid-crystal device according to various aspects of the present disclosure.

FIG. 5D is an application schematic diagram of another exemplary embodiment of the liquid-crystal device according to various aspects of the present disclosure.

FIG. 6A is a schematic diagram of an exemplary embodiment of a driving device according to various aspects of the present disclosure.

FIG. 6B is a schematic diagram of another exemplary embodiment of the driving device according to various aspects of the present disclosure.

FIG. 7A is a schematic diagram of another exemplary embodiment of the driving device according to various aspects of the present disclosure.

FIG. 7B is a schematic diagram of another exemplary embodiment of the driving device according to various aspects of the present disclosure.

FIG. 8 is a schematic diagram of an exemplary embodiment of a countering circuit and a voltage division circuit according to various aspects of the present disclosure.

FIG. 9 is a schematic diagram of an exemplary embodiment of a conversion circuit according to various aspects of the present disclosure.

FIG. 10A is a schematic diagram of an exemplary embodiment of a touch circuit according to various aspects of the present disclosure.

FIG. 10B is a schematic diagram of another exemplary embodiment of the touch circuit according to various aspects of the present disclosure.

FIG. 10C is a schematic diagram of another exemplary embodiment of the touch circuit according to various aspects of the present disclosure.

### DETAILED DESCRIPTION OF THE DISCLOSURE

The present disclosure will be described with respect to particular embodiments and with reference to certain drawings, but the disclosure is not limited thereto and is limited by the claims. The drawings described are schematic and are non-limiting. In the drawings, the size of some of the elements may be exaggerated for illustrative purposes and not drawn to scale. The dimensions and the relative dimensions do not correspond to actual dimensions in the practice of the disclosure.

In the specification and appended claims, certain words are used to refer to specific elements. Those skilled in the art should understand that electronic device manufacturers may refer to the same components by different names. The disclosure does not intend to distinguish those elements with the same function but different names. In the following description and claims, words such as “comprise”, “include”, and “have” are open words. Therefore, they should be interpreted as meaning “including, but are not limited to . . . ”. Therefore, when the terms “comprise”, “include” and/or “have” are used in the description of this disclosure, they specify the existence of corresponding features, regions, steps, operations, and/or components, but do not exclude one or more. The existence of corresponding features, regions, steps, operations and/or components.

When a corresponding member (such as a film layer or region) is referred to as being “on” or “on” another member, it can be directly on the member, or there may be other members between the two. On the other hand, when a component is called “directly on another component”, there is no component between the two. In addition, when a member is called “on another member”, the two have a vertical relationship in the top view direction, and this member can be above or below the other member, and this vertical relationship depends on the orientation of the device.

The terms “approximately”, “equal”, or “same”, “substantially” or “substantially” are generally interpreted as being within 20% of a given value or range, or interpreted as being within 10%, 5%, 3%, 2%, 1%, or 0.5% of a given value or range.

It should be noted that the technical features in different embodiments described in the following can be replaced, recombined, or mixed with one another to constitute another embodiment without departing from the spirit of the present disclosure.

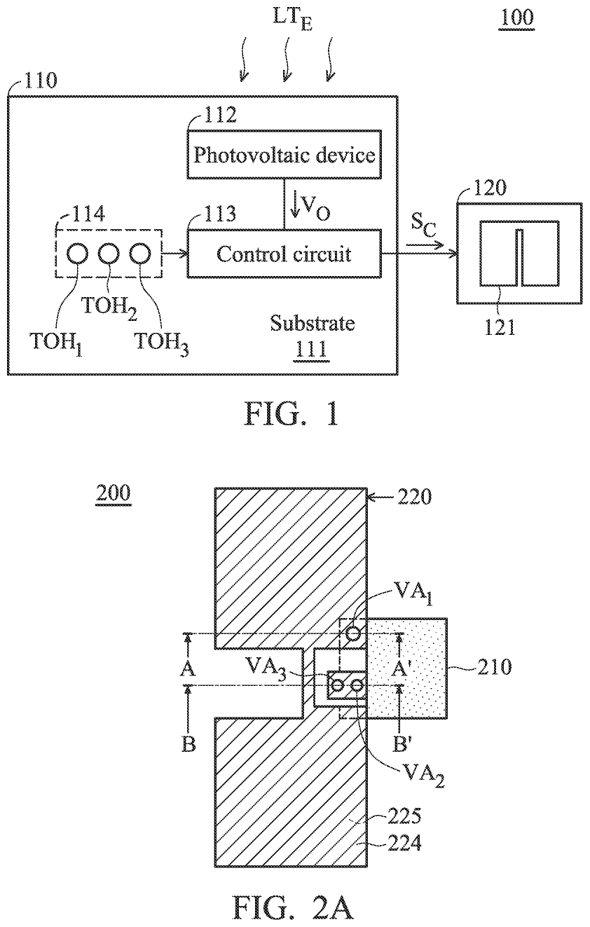

FIG. 1 is a schematic diagram of an exemplary embodiment of a liquid-crystal device according to various aspects of the present disclosure. The liquid-crystal device 100 may comprise a driving device 110 and a liquid-crystal module 120. The driving device 110 may provide a control signal Sc to the liquid-crystal module 120 to control the transmittance of the liquid-crystal module 120. In one embodiment, the control signal Sc may comprise at least one voltage to control the cross voltage of the liquid-crystal layer of the liquid-crystal module 120.

The application of the liquid-crystal module 120 is not limited in the present disclosure. In one embodiment, the liquid-crystal module 120 is made into a pair of glasses 121. These glasses 121 may be sunglasses, but the disclosure is not limited thereto. In such cases, when the intensity of the external light LTE is great, the transmittance of the liquid-crystal module 120 is low. In other embodiments, the glasses 121 may be made into a visor of a helmet, a car window, or the windows of a building, but the disclosure is not limited thereto.

In this embodiment, the driving device 110 utilizes the external light LTE to generate power. Therefore, there is no battery in the driving device 110, but the disclosure is not limited thereto. In other embodiments, the driving device 110 may comprise a battery to provide auxiliary power. The power of the liquid-crystal device 100 is considered to determine whether to use the element that generates power according to the external light LTE. In another embodiment, the driving device 110 adjusts the control signal Sc according to the intensity of the external light LTE to change the transmittance of the liquid-crystal module 120. For example, when the intensity of the external light LTE is large, the driving device 110 utilizes the control signal Sc to reduce the transmittance of the liquid-crystal module 120. When the intensity of the external light LTE is weak, the driving device 110 utilizes the control signal Sc to increase the transmittance of the liquid-crystal module 120. Therefore, there is no additional light sensor in the driving device 110.

In one embodiment, the driving device 110 may comprise a substrate 111, a photovoltaic device 112, and a control circuit 113. The photovoltaic device 112 and the control circuit 113 are disposed on the substrate 111. In one embodiment, the control circuit 113 is located between the substrate 111 and the photovoltaic device 112, but the disclosure is not limited thereto. The material of substrate 111 is not limited in the present disclosure. In one embodiment, the material of substrate 111 is polyethylene terephthalate (PET), glasses, polymer, ceramic, other suitable materials, or a combination thereof. In some embodiments, the substrate 111 is a transparent substrate or a flexible substrate.

The photovoltaic device 112 may convert the external light LTE to generate an output voltage V_{O}. In one embodiment, the photovoltaic device 112 is made by a low temperature polysilicon (LTPS) manufacturing process, an amorphous silicon (a-Si) manufacturing process, or an indium-gallium-zinc-oxide (IGZO) manufacturing process, but the disclosure is not limited thereto. In some embodiments, the photovoltaic device 112 may comprise a plurality of photovoltaic elements. In such cases, the photovoltaic elements are formed by a thin-film fabrication. In other embodiments, the photovoltaic device 112 comprises at least one photo-diode, such as a thin-film solar diode.

The control circuit 113 may receive the output voltage V_{O} and generate the control signal Sc. In this embodiment, the output voltage V_{O} serves as an operation voltage of the control circuit 113. Therefore, when the control circuit 113 receives the output voltage V_{O}, the control circuit 113 can generate the control signal Sc. Since the operation voltage of the control circuit 113 is provided from the photovoltaic device 112, no additional recharge battery is disposed in the driving device 110. Furthermore, since the driving device 110 may not receive external charging power, no charging contacts are disposed on the outside of driving device 110. Therefore, the waterproof performance of the driving device 110 is increased.

In other embodiments, the control circuit 113 determines the intensity of the external light LTE according to the output voltage V_{O} and then adjusts the control signal Sc according to the intensity of an external light LTE. In one embodiment, the control circuit 113 comprises a plurality of transistors (not shown). The transistors are formed on the substrate 111. In other embodiments, the control circuit 113 is formed by the LTPS manufacturing process, the a-Si manufacturing process, or the IGZO manufacturing process, but the disclosure is not limited thereto.

In some embodiment, if the photovoltaic device 112 does not detect the external light LTE, the photovoltaic device 112 may stop providing power temporarily. Therefore, the control circuit 113 stops generating the control signal Sc. At this time, since the liquid-crystal module 120 does not receive the control signal Sc, the liquid-crystal module 120 may be in a normally-white state. Therefore, the user can see the front view via the sunglasses. In other embodiments, the control circuit 113 may comprise an energy storage element. When the photovoltaic device 112 provides the power normally, the energy storage element stores energy. When the photovoltaic device 112 stops providing the power, the energy stored in the energy storage element can maintain the operation of the control circuit 113. In such cases, the control circuit 113 may gradually increase the transmittance of the liquid-crystal module 120 according to the energy stored in the energy storage element.

In other embodiments, the driving device 110 may further comprise a sensing circuit 114. The sensing circuit 114 is formed on the substrate 111. In such cases, the sensing circuit 114 serves as an input interface for the user to switch the operation mode of the control circuit 113. For brevity, FIG. 1 shows the touch circuits TOH₁˜TOH₃, but the disclosure is not limited thereto. In other embodiments, the sensing circuit 114 comprises more or fewer touch circuits.

In this embodiment, the touch circuit TOH₁ may serve as a mode switching circuit to switch the operation mode of the control circuit 113. For example, when the user touches the touch circuit TOH₁, the operation mode of the control circuit 113 is changed from a manual mode to an automatic mode or from an automatic mode to a manual mode.

In the manual mode, the control circuit 113 may determine whether the user touches the touch circuits TOH₂ and TOH₃. When the user touches the touch circuit TOH₂, it means that the user wants to increase the transmittance of the liquid-crystal module 120. Therefore, the control circuit 113 increases the transmittance of the liquid-crystal module 120 via the control signal Sc. In one embodiment, the transmittance of the liquid-crystal module 120 relates to the number of times that the touch circuit TOH₂ is touched, but the disclosure is not limited thereto. With an increase in the number of times that the touch circuit TOH₂ is touched, the transmittance of the liquid-crystal module 120 is high. When the user touches the touch circuit TOH₃, it means that the user wants to reduce the transmittance of the liquid-crystal module 120. Therefore, the control circuit 113 reduces the transmittance of the liquid-crystal module 120 via the control signal Sc. In one embodiment, the transmittance of the liquid-crystal module 120 relates to the number of times that the touch circuit TOH₃ is touched. When the number of times that the touch circuit TOH₃ is touched is increased, the transmittance of the liquid-crystal module 120 is low, but the disclosure is not limited thereto.

In the automatic mode, the control circuit 113 auto-adjusts the transmittance of the liquid-crystal module 120 according to the intensity of the external light LTE. At this time, the control circuit 113 may ignore the touch events on the touch circuit TOH₂ or TOH₃ until the user touches the touch circuit TOH₁.

In some embodiments, the driving device 110 and the liquid-crystal module 120 are formed on different substrates. In other words, the substrate of the driving device 110 is independent of the substrate of the liquid-crystal module 120. In other embodiments, the driving device 110 and the liquid-crystal module 120 share at least one substrate. For example, the liquid-crystal module 120 may comprise an upper-substrate and a bottom-substrate. In such cases, the driving device 110 may share the upper-substrate or the bottom-substrate, or a portion of the driving device 110 shares the upper-substrate and the other portion of the driving device 110 shares the bottom-substrate. In such cases, since the driving device 110 shares the substrate of the liquid-crystal module 120, the driving device 110 and the liquid-crystal module 120 relate to an integrally-formed set. Since the driving device 110 and the liquid-crystal module 120 are combined into the same substrate, it can simplify the manufacturing processes and increase the waterproof performance of the liquid-crystal device 100.

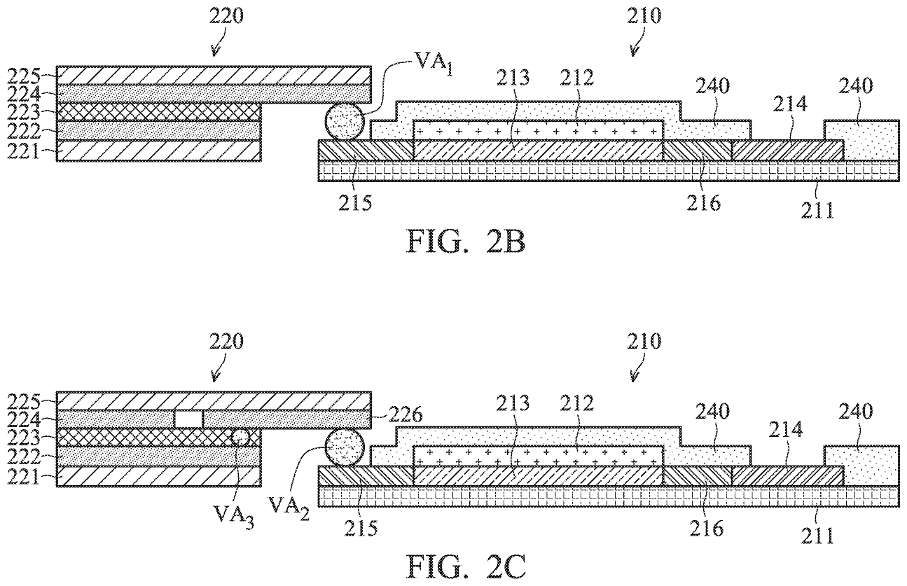

FIG. 2A is a top view of an exemplary embodiment of the liquid-crystal device according to various aspects of the present disclosure. In this embodiment, the liquid-crystal device is applied to a pair of sunglasses. In such cases, the driving device 210 may be electrically connected to an upper conductive layer 224 of the liquid-crystal module 220 via the through-hole VA₁ to control the voltage of the upper conductive layer 224. Additionally, the driving device 210 may be electrically connected to a bottom conductive layer 222 (shown in FIG. 2C) of the liquid-crystal module 220 via the through-holes VA₂ and VA₃ to control the voltage of the bottom conductive layer 222.

Since the liquid-crystal component of the liquid-crystal module 220 is enclosed between the upper conductive layer 224 and the bottom conductive layer 222, when the driving device 210 controls the voltages of the upper conductive layer 224 and the bottom conductive layer 222, the arrangement of the liquid-crystal component can be changed to change the transmittance of the liquid-crystal module 220. The disclosure does not limit how the driving device 210 controls the voltages of the upper conductive layer 224 and the bottom conductive layer 222. In one embodiment, the driving device 210 fixes the voltage of either the upper conductive layer 224 or the bottom conductive layer 222, and changes the voltage of the other of either the upper conductive layer 224 or the bottom conductive layer 222. In one embodiment, the voltage of the upper conductive layer 224 or the bottom conductive layer 222 is a ground voltage.

FIG. 2B is a cross-section view of an exemplary embodiment of the liquid-crystal device along the dotted line AA′ in FIG. 2A. In this embodiment, the substrate of the driving device 210 is independent of the substrate of the liquid-crystal module 220. As shown in FIG. 2B, the driving device 210 comprises a substrate 211. In one embodiment, the substrate 211 is a flexible substrate or a transparent substrate, but the disclosure is not limited thereto.

The control circuit 213 is formed on the substrate 211. In this embodiment, the control circuit 213 directly contacts the substrate 211. In one embodiment, the control circuit 213 is formed by a thin-film manufacturing process. In other embodiments, the control circuit 213 may comprise multiple thin-film transistors (TFTs), but the disclosure is not limited thereto.

The photovoltaic device 212 may be formed on the control circuit 213. In this embodiment, the photovoltaic device 212 may be in direct contact with the control circuit 213 and overlap the control circuit 213. In one embodiment, the photovoltaic device 212 is formed by a thin-film manufacturing process, but the disclosure is not limited thereto. In other embodiments, the photovoltaic device 212 comprises multiple photodiodes (not shown) that converts light signals into electrical signals. In one embodiment, the photodiodes are P/i/P diodes. Additionally, the photodiodes are arranged into a matrix.

In other embodiments, the driving device 210 may further comprise a sensing circuit 214. In such cases, the sensing circuit 214 may be formed on the substrate 211. In such cases, the sensing circuit 214 and the control circuit 213 are formed at the same time. Additionally, the sensing circuit 214 may transmit signals to the control circuit 213 via the routings (not shown) of a routing area 216. Furthermore, the control circuit 213 may electrically connect to the through-hole VA₁ via the routings (not shown) of another routing area 215 to transmit the control signal to the liquid-crystal module 220.

The cover layer 240 covers a portion of the routing area 215, the photovoltaic device 212, the routing area 216, a portion of the sensing circuit 214, and a portion of the substrate 211. In this embodiment, since the cover layer 240 does not cover the sensing circuit 214 completely, the sensitivity of the sensing circuit 214 is increased. In another embodiment, the cover layer 240 covers the sensing circuit 214 completely, but the thickness of the cover layer 240 on the sensing circuit 214 may be lower than the thickness of the cover layer 240 on the routing area 216. In such cases, the sensing circuit 214 can still sense the touch action of the user.

The liquid-crystal module 220 may comprise the substrates 221 and 225, the bottom conductive layer 222, the upper conductive layer 224, and a liquid-crystal layer 223. The kinds of substrates 221 and 225 are not limited in the present disclosure. In one embodiments, the substrates 221 and 225 are transparent substrates, but the disclosure is not limited thereto. In this embodiment, the substrates 221, 225 and 211 are independent from one another.

The bottom conductive layer 222 is formed on the substrate 221. In one embodiment, the bottom conductive layer 222 may be a transparent conductive layer, such as a indium tin oxide (ITO) conductive layer. The liquid-crystal layer 223 is disposed on the bottom conductive layer 222. In some embodiments, the area of the substrate 221 may be approximately equal to the area of the bottom conductive layer 222 and the area of the liquid-crystal layer 223. The upper conductive layer 224 is disposed on the liquid-crystal layer 223. In this embodiment, the upper conductive layer 224 may be electrically connected to the through-hole VA₁. Therefore, the control circuit 213 can control the voltage of the upper conductive layer 224 via the routing area 215 and the through-hole VA₁. Since the feature of the upper conductive layer 224 is similar to the feature of the bottom conductive layer 222, the description of the upper conductive layer 224 is omitted. In one embodiment, the area of the upper conductive layer 224 may be larger than the area of the bottom conductive layer 222, but the disclosure is not limited thereto. In this embodiment, the liquid-crystal layer 223 is enclosed between the bottom conductive layer 222 and the upper conductive layer 224. The substrate 225 may be disposed on the upper conductive layer 224. In one embodiment, the area of the substrate 225 may be larger than the area of the substrate 221. In other embodiments, the area of the substrate 225 is approximately equal to the area of the upper conductive layer 224.

FIG. 2C is a cross-section view of an exemplary embodiment of the liquid-crystal device along the dotted line BB′ in FIG. 2A. FIG. 2C is similar to FIG. 2B, exception that the liquid-crystal module 220 further comprises a conductive layer 226. The conductive layer 226 may be disposed between the liquid-crystal layer 223 and the substrate 225. A gap is between the conductive layers 226 and 224. In this embodiment, the conductive layer 226 may be electrically connected to the through-holes VA₂ and VA₃. The through-hole VA₃ may be between the conductive layer 226 and the bottom conductive layer 222. In such case, the control circuit 213 controls the voltage of the bottom conductive layer 222 via the through-hole VA₂, the conductive layer 226, and the through-hole VA₃.

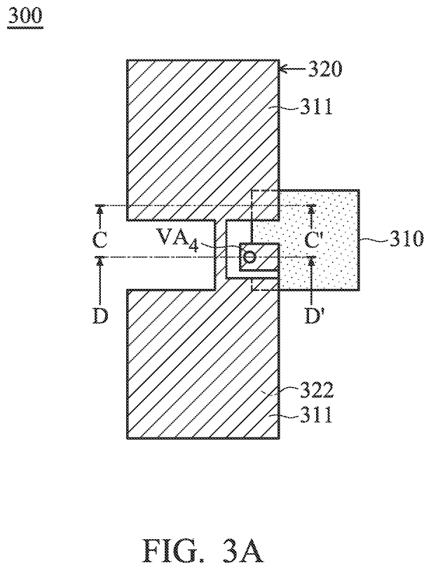

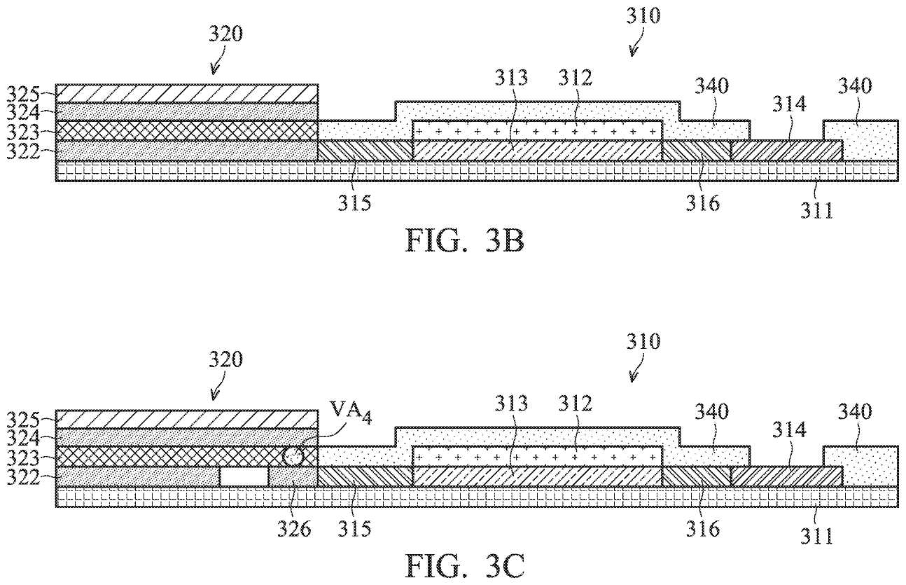

FIG. 3A is a top view of an exemplary embodiment of the liquid-crystal device according to various aspects of the present disclosure. In this embodiment, the driving device 310 and the liquid-crystal module 320 share the same substrate. The driving device 310 is electrically connected to the upper conductive layer 324 (shown in FIG. 3C) of the liquid-crystal module 320 via the through-hole VA₄ to control the voltage of the upper conductive layer 324. FIG. 3B is a cross-section view of an exemplary embodiment of the liquid-crystal device along the dotted line CC′ in FIG. 3A. As shown in FIG. 3B, the driving device 310 comprises a substrate 311. The substrate 311 may be a flexible substrate or a transparent substrate, but the disclosure is not limited thereto.

The control circuit 313 is formed on the substrate 311. The photovoltaic device 312 is formed on the control circuit 313. Since the features of the photovoltaic device 312 and the control circuit 313 are the same as the features of the photovoltaic device 212 and the control circuit 213 of FIG. 2B, the descriptions of the photovoltaic device 312 and the control circuit 313 are omitted.

In other embodiments, the driving device 310 further comprises a sensing circuit 314. In such cases, the sensing circuit 314 is formed on the substrate 311. Since the feature of the sensing circuit 314 is the same as the feature of the sensing circuit 214 of FIG. 2B, the description of the sensing circuit 314 is omitted. Additionally, the sensing circuit 314 may transmit signals to the control circuit 313 via the routings (not shown) of a routing area 316. In such cases, the control circuit 313 may control the voltage of the bottom conductive layer 322 of the liquid-crystal module 320 via the routings (not shown) of another routing area 315.

The cover layer 340 covers the routing area 315, the photovoltaic device 312, the routing area 316, a portion of the sensing circuit 314, and a portion of the substrate 311. Since the feature of the cover layer 340 is the same as the feature of the cover layer 240 of FIG. 2B, the description of the cover layer 340 is omitted.

In this embodiment, the liquid-crystal module 320 and the driving device 310 share the substrate 311. In such cases, the bottom conductive layer 322 of the liquid-crystal module 320 is formed on the substrate 311. The bottom conductive layer 322 receives the control signal provided from the control circuit 313 via the routings of the routing area 315. The liquid-crystal layer 323 is disposed on the bottom conductive layer 322. The upper conductive layer 324 is disposed on the liquid-crystal layer 323. The substrate 325 is disposed on the upper conductive layer 324. Since the features of the bottom conductive layer 322, the liquid-crystal layer 323, the upper conductive layer 324, and the substrate 325 are the same as the features of the bottom conductive layer 222, the liquid-crystal layer 223, the upper conductive layer 224, and the substrate 225 of FIG. 2B, the descriptions of the features of the bottom conductive layer 322, the liquid-crystal layer 323, the upper conductive layer 324, and the substrate 325 are omitted.

FIG. 3C is a cross-section view of an exemplary embodiment of the liquid-crystal device along the dotted line DD′ in FIG. 3A. FIG. 3C is similar to FIG. 3B, exception that the liquid-crystal module 320 may comprise a conductive layer 326. The conductive layer 326 may be disposed between the substrate 311 and the liquid-crystal layer 323. A gap is between the conductive layer 326 and the bottom conductive layer 322. In this embodiment, the through-hole VA₄ may be connected to the upper conductive layer 324 and the conductive layer 326. In such cases, the control circuit 313 may control the voltage of the upper conductive layer 324 via the routings of the routing area 315, the conductive layer 326 and the through-hole VA₄.

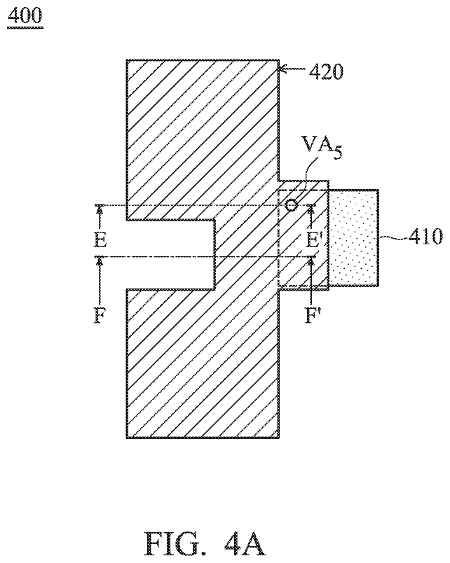

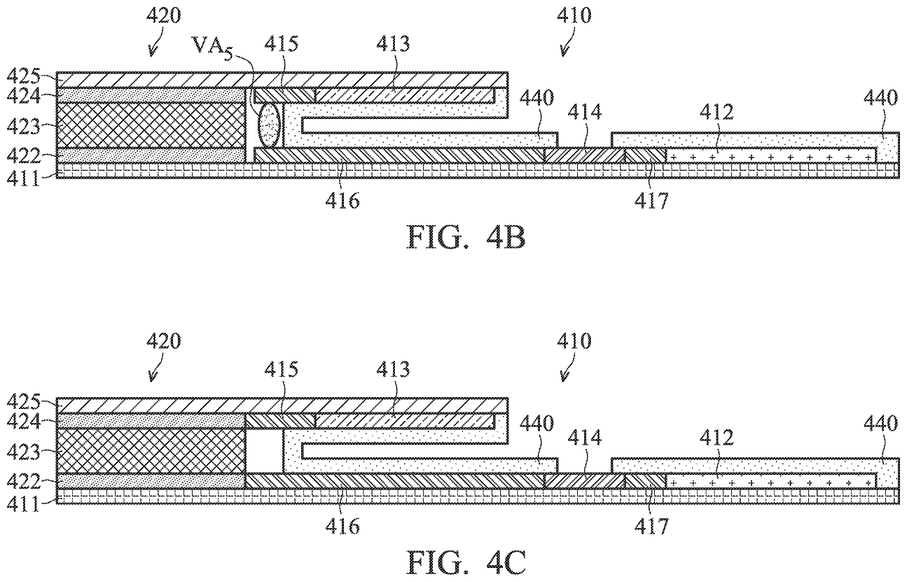

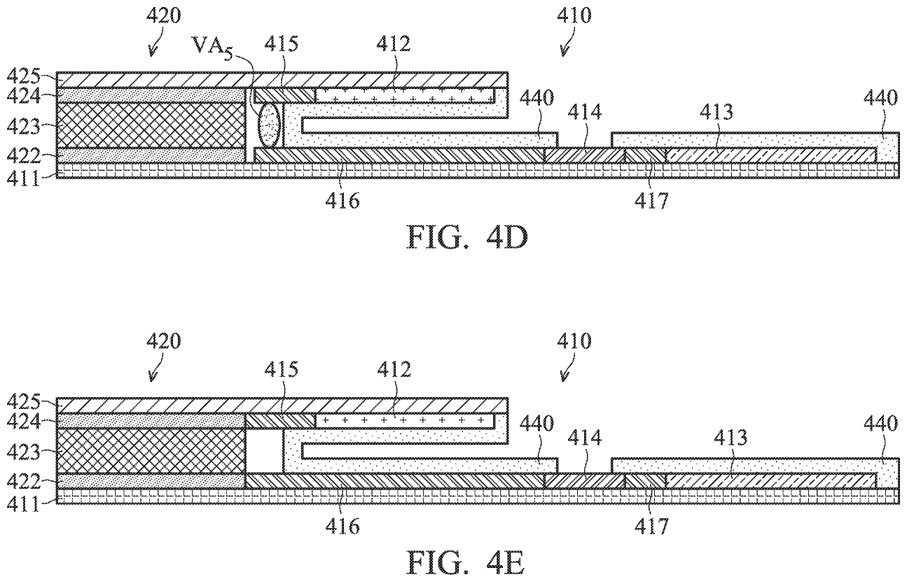

FIG. 4A is a top view of another exemplary embodiment of the liquid-crystal device according to various aspects of the present disclosure. In this embodiment, the driving device 410 and the liquid-crystal module 420 share two substrates. Additionally, the driving device 410 is electrically connected to the liquid-crystal module 420 via the through-hole VA₅.

FIG. 4B is a cross-section view of an exemplary embodiment of the liquid-crystal device along the dotted line EE′ in FIG. 4A. In this embodiment, the driving device 410 and the liquid-crystal module 420 share the substrates 411 and 425. As shown in FIG. 4B, the photovoltaic device 412 and the bottom conductive layer 422 may be formed on the substrate 411. In such cases, the photovoltaic device 412 and the bottom conductive layer 422 are in direct contact with the substrate 411. Since the features of the photovoltaic device 412 is the same as the features of the photovoltaic device 212 shown in FIG. 2B, the description of the features of the photovoltaic device 412 is omitted.

In other embodiments, the driving device 410 may further comprise a sensing circuit 414. In such cases, the sensing circuit 414 is also formed on the substrate 411. The position of sensing circuit 414 is not limited in the present disclosure. In one embodiment, the sensing circuit 414 may be disposed between the photovoltaic device 412 and the bottom conductive layer 422. In another embodiment, the photovoltaic device 412 may be disposed between the sensing circuit 414 and the bottom conductive layer 422. Since the feature of the sensing circuit 414 is the same as the feature of the sensing circuit 214 of FIG. 2B, the feature of the sensing circuit 414 is omitted.

The control circuit 413 and the upper conductive layer 424 share the substrate 425. In this embodiment, the control circuit 413 and the upper conductive layer 424 are in direct contact with the substrate 425. Since the feature of the control circuit 413 is the same as the feature of the control circuit 213 of FIG. 2B, the description of the feature of the control circuit 413 is omitted. Additionally, the liquid-crystal layer 423 is enclosed between the upper conductive layer 424 and the bottom conductive layer 422. Since the features of the liquid-crystal layer 423, the upper conductive layer 424 and the bottom conductive layer 422 are the same as the features of the liquid-crystal layer 223, the upper conductive layer 224 and the bottom conductive layer 222 of FIG. 2B, the descriptions of the features of the liquid-crystal layer 423, the upper conductive layer 424 and the bottom conductive layer 422 are omitted.

In this embodiment, the control circuit 413 is electrically connected to the through-hole VA₅ via the routings (not shown) of the routing area 415. The through-hole VA₅ is electrically connected to the routings of the routing areas 415 and 416. Therefore, the sensing circuit 414 can transmit signals to the control circuit 413 via the routings of the routing area 416, the through-hole VA₅, and the routings of the routing area 415. Additionally, the sensing circuit 414 also comprises transmission routings (not shown). In such cases, the photovoltaic device 412 can transmit signals and/or powers to the control circuit 413 via the routings of the routing area 417, the transmission routings of the sensing circuit 414, the routings of the routing area 416, the through-hole VA₅, and the routings of the routing area 415.

In other embodiments, the cover layer 440 covers the substrate 425, the control circuit 413, a portion of the routing area 415, the through-hole VA₅, a portion of the routing area 416, a portion of the sensing circuit 414, the routing area 417, the photovoltaic device 412, and the substrate 411. Since the feature of cover layer 440 is the same as the feature of cover layer 240 of FIG. 2B, the description of the feature of cover layer 440 is omitted.

FIG. 4C is a cross-section view of an exemplary embodiment of the liquid-crystal device along the dotted line FF′ in FIG. 4A. As shown in FIG. 4C, the control circuit 413 can control the voltage of the upper conductive layer 424 via the routings of the routing area 415. Additionally, since the routings of the routing area 416 are electrically connected to the bottom conductive layer 422, the control circuit 413 can control the voltage of the bottom conductive layer 422 via the routings of the routing area 415, the through-hole VA₅, and the routings of the routing area 416. The transmittance of the liquid-crystal layer 423 is controlled according to the voltages of the upper conductive layer 424 and the bottom conductive layer 422.

FIG. 4D is a cross-section view of another exemplary embodiment of the liquid-crystal device along the dotted line EE′ in FIG. 4A. FIG. 4D is similar to FIG. 4B, exception that the control circuit 413 and the bottom conductive layer 422 share the substrate 411, and the photovoltaic device 412 and the upper conductive layer 424 share the substrate 425 in FIG. 4D. In this embodiment, the control circuit 413 can electrically connect to the sensing circuit 414 via the routings of the routing area 417. Furthermore, the sensing circuit 414 can electrically connect to the photovoltaic device 412 via the routings of the routing area 416, the through-hole VA₅, and the routings of the routing area 415.

FIG. 4E is a cross-section view of another exemplary embodiment of the liquid-crystal device along the dotted line FF′ in FIG. 4A. FIG. 4E is similar to FIG. 4D. In FIG. 4E, the photovoltaic device 412 is electrically connected to the upper conductive layer 424 via the routings of the routing area 415.

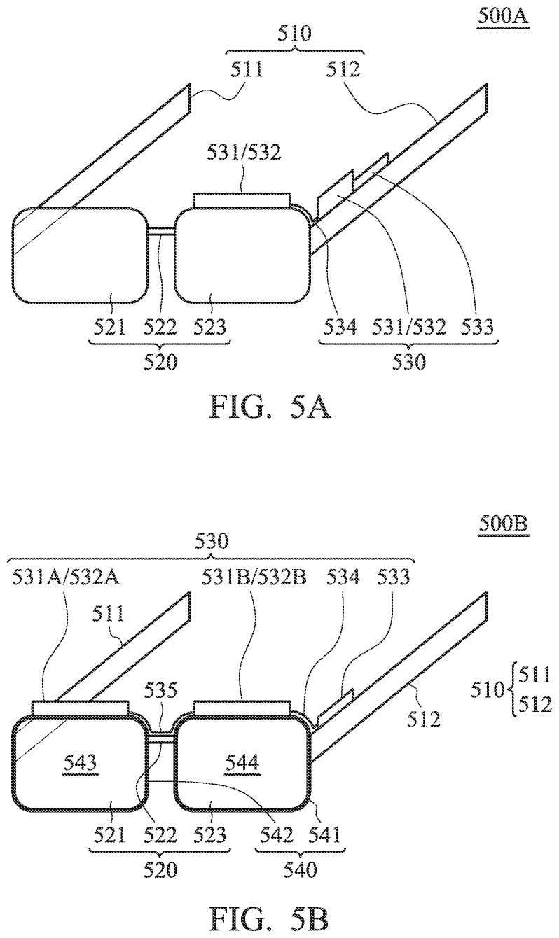

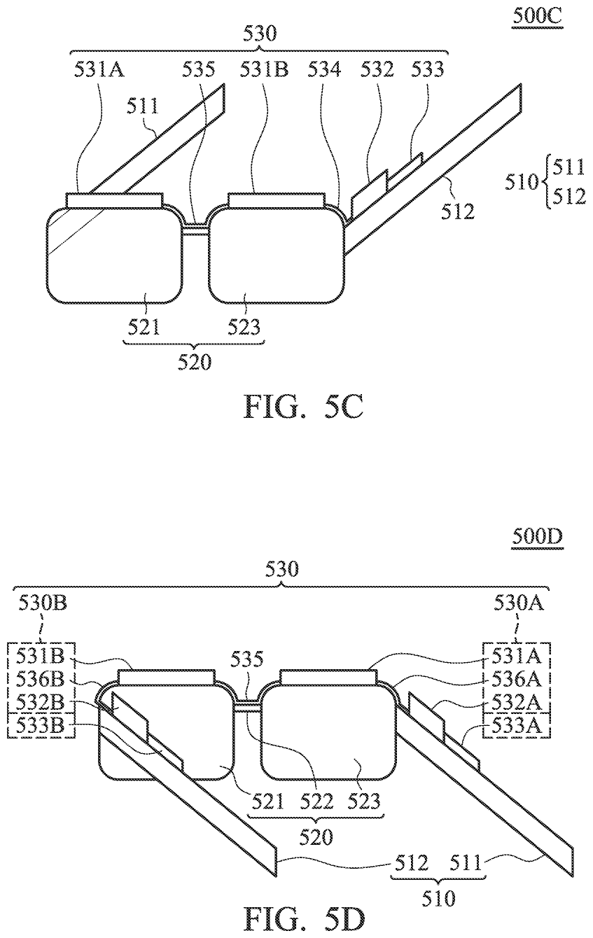

FIGS. 5A-5D are application schematic diagrams of exemplary embodiments of the liquid-crystal device according to various aspects of the present disclosure. In FIG. 5A, the sunglasses 500A may comprise a spectacle frame 510, a liquid-crystal module 520 and a driving device 530. The spectacle frame 510 may be configured to hold the liquid-crystal module 520. In this embodiment, the spectacle frame 510 comprises temples 511 and 512. In such cases, the sunglasses 500A may be a rimless glasses, but the disclosure is not limited thereto. Therefore, temples 511 and 512 are in direct contact with the two sides of the liquid-crystal module 520, respectively.

In this embodiment, the liquid-crystal module 520 serves as the lenses of the sunglasses 500A. The liquid-crystal module 520 comprises a first part 521, a connection part 522, and a second part 523. The connection part 522 is configured to connect the first part 521 to the second part 523.

The control circuit 531 and the photovoltaic device 532 of the driving device 530 may be disposed on the temple 512 and/or the second part 523, but the disclosure is not limited thereto. The photovoltaic device 532 can receive an external light and convert the external light into an electrical signal to provide power to the control circuit 531. The control circuit 531 transmits control signals to the liquid-crystal module 520 via the routings of the routing area 534 to control the transmittance of the liquid-crystal module 520. In one embodiment, with an increase in the intensity of the external light, the transmittance of the liquid-crystal module 520 is low. With a decrease in the intensity of the external light, the transmittance of the liquid-crystal module 520 is high. In other embodiments, when the intensity of the external light is lower than a lower limit value, the liquid-crystal module 520 has the largest light transmittance. At this time, the liquid-crystal module 520 is in a transparent state.

In other embodiments, the driving device 530 further comprises a sensing circuit 533. The sensing circuit 533 serves as an input interface. In such cases, the user can use the sensing circuit 533 to adjust the transmittance of the liquid-crystal module 520. In one embodiment, the sensing circuit 533 comprises a plurality of sensing elements (not shown). When the user touches a first sensing element of the sensing circuit 533, it means that the user wants to manually control the transmittance of the liquid-crystal module 520. Therefore, the control circuit 531 may enter a manual mode. In the manual mode, the control circuit 531 increases or reduces the transmittance of the liquid-crystal module 520 according to the touch action of the user. For example, when the user touches a second sensing element of the sensing circuit 533, it means that the user wants to increase the transmittance of the liquid-crystal module 520. Therefore, the control circuit 531 gradually increases the transmittance of the liquid-crystal module 520 according to the number of times that the user touches the second sensing element. When the user touches a third sensing element of the sensing circuit 533, it means that the user wants to reduce the transmittance of the liquid-crystal module 520. Therefore, the control circuit 531 gradually reduces the transmittance of the liquid-crystal module 520 according to the number of times that the user touches the third sensing element. In other embodiments, when the user touches the first sensing element again, the control circuit 531 may enter an automatic mode. In the automatic mode, the control circuit 531 controls the transmittance of the liquid-crystal module 520 according to the detection result generated by the photovoltaic device 532.

In FIG. 5B, the sunglasses 500B comprises a spectacle frame 510, a liquid-crystal module 520, a driving device 530, and a spectacle rim 540. In this embodiment, the spectacle rim 540 is between the liquid-crystal module 520 and the spectacle frame 510. The spectacle rim 540 comprises a first part (referred to as a right-frame) 541 and a second part (referred to as a left-frame) 542. The right-frame 541 is connected to the temple 512 and has a hollow area 544. The hollow area 544 is located in a first side (referred to as an inner side) of the right-frame 541 to put the second part 523 of the liquid-crystal module 520. The left-frame 542 is connected to the temple 511 and has a hollow area 543. The hollow area 543 is located in a first side (referred to as an inner side) of the left-frame 542 to put the first part 521 of the liquid-crystal module 520.

In this embodiment, the control circuit 531A and the photovoltaic device 532A are disposed in a second side (referred to as an outer side) of the left-frame 542. In such cases, the position (the second side of the left-frame 542) of each of the control circuit 531A and the photovoltaic device 532A is opposite to the position (the first side of the left-frame 542) of the first part 521 of the liquid-crystal module 520. The photovoltaic device 532A converts an external light and provides power to the control circuit 531A. The control circuit 531A generates control signals to the first part 521. In one embodiment, the control circuit 531A transmits control signals to the first part 521 of the liquid-crystal module 520 via the routings of the routing area 535 to control the transmittance of the first part 521.

Additionally, the control circuit 531B and the photovoltaic device 532B are disposed in a second side (referred to as an outer side) of the right-frame 541. In such cases, the position (the second side of the right-frame 541) of each of the control circuit 531B and the photovoltaic device 532B is opposite to the position (the first side of the right-frame 541) of the second part 523 of the liquid-crystal module 520. The photovoltaic device 532B converts an external light and provides power to the control circuit 531B. In one embodiment, the photovoltaic device 532B converts the external light into an electrical signal and then provides the electrical signal to the control circuit 531B. The control circuit 531B generates control signals to the second part 523 of the liquid-crystal module 520. In one embodiment, the control circuit 531B transmits control signals to the second part 523 via the routings of the routing area 535 to control the transmittance of the second part 523.

In other embodiments, a sensing circuit 533 may be disposed on the temple 512. When the user touches the sensing circuit 533, the sensing circuit 533 activates the control circuits 531A and 531B via the routings of the routing areas 534 and 535 so that the control circuits 531A and 531B enter a manual mode or an automatic mode. In the manual mode, the control circuits 531A and 531B respectively or simultaneously control the transmittance of the first part 521 and the second part 523 of the liquid-crystal module 520 according to the needs of the user. In the automatic mode, the control circuits 531A and the 531B control the transmittance of the first part 521 and the second part 523 of the liquid-crystal module 520 according to the electrical signals provided by the photovoltaic devices 532A and 532B.

FIG. 5C is similar to FIG. 5B, exception that the photovoltaic device 532 is disposed on the temple 512 in FIG. 5C. In such cases, the photovoltaic device 532 may provide power to the control circuits 531A and 531B via the routings of the routing areas 534 and 535. In other embodiments, the photovoltaic device 532 may also provide power to the sensing circuit 533. Additionally, the control circuits 531A and 531B may be coupled to the sensing circuit 533 via the routings of the routing areas 535 and 534, and the photovoltaic device 532 to receive information provided by the user.

In FIG. 5D, the sunglasses 500D may comprise a spectacle frame 510, a liquid-crystal module 520, and a driving device 530. The driving device 530 may comprise a first part 530A and a second part 530B. The first part 530A may comprise a control circuit 531A, a routing area 536A and a photovoltaic device 532A. The photovoltaic device 532A may supply power to the control circuit 531A via the routings of the routing area 536A according to an external light. Additionally, the control circuit 531A determines the intensity of the external light according to the electrical signals provided by the photovoltaic device 532A. Then, control circuit 531A dynamically adjusts the transmittance of the second part 523 of the liquid-crystal module 520 according to the intensity of the external light. In this embodiment, the control circuit 531A may overlap the second part 523 of the liquid-crystal module 520, and the photovoltaic device 532A and the routing area 536A may be disposed on the temple 511.

The second part 530B of the driving device 530 may comprise the control circuit 531B, a routing area 536B and the photovoltaic device 532B. Since the features of the control circuit 531B, the photovoltaic device 532B, and the routing area 536B are the same as the features of the control circuit 531A, the photovoltaic device 532A, and the routing area 536A, the descriptions of the features of the control circuit 531B, the photovoltaic device 532B, and the routing area 536B are omitted.

In this embodiment, the driving device 530 may further comprise sensing circuits 533A and 533B. The sensing circuit 533A is disposed on the temple 511. The sensing circuit 533B is disposed on the temple 512. In such cases, the user may use the sensing circuits 533A and 533B to respectively or simultaneously adjust the transmittance of the first part 521 and the second part 523 of the liquid-crystal module 520.

In other embodiments, the sunglasses 500D may further comprise a spectacle frame (not shown). The spectacle frame is configured to hold the first part 521 and the second part 523 of the liquid-crystal module 520. In such cases, the control circuits 531A and 531B are disposed in the outer side of the spectacle frame, and the first part 521 and the second part 523 of the liquid-crystal module 520 are disposed in the inner side of the spectacle frame.

In FIGS. 5A-5D, the driving device 530 and the liquid-crystal module 520 may be disposed in different substrates or in the same substrate, but the disclosure is not limited thereto. For example, in FIGS. 2B and 2C, the driving device 210 (or the driving device 530 shown in FIGS. 5A-5D) is disposed on the substrate 211, and the liquid-crystal module 220 (or the liquid-crystal module 520 shown in FIGS. 5A-5D) is disposed on the substrate 221. In such cases, the substrate 211 is independent of the substrate 221.

In other embodiments, the driving device 530 and the liquid-crystal module 520 shown in FIGS. 5A-5D share at least one substrate. Taking FIGS. 3B and 3C as an example, the driving device 310 (or 530) and the liquid-crystal module 320 (or 520) share the substrate 311. Additionally, in FIGS. 4B and 4C, the photovoltaic device 412 (or 532) of the driving device 410 (or 530) and the liquid-crystal module 420 (or 520) may share the substrate 411. The control circuit 413 (or 531/531A/531B) of the driving device 410 (or 530) and the liquid-crystal module 420 (or 520) may share the substrate 425. In FIGS. 4D and 4E, the control circuit 413 (or 531/531A/531B) of the driving device 410 (or 530) and the liquid-crystal module 420 (or 520) may share the substrate 411. The photovoltaic device 412 (or 532) of the driving device 410 (or 530) and the liquid-crystal module 420 (or 520) may share the substrate 425.

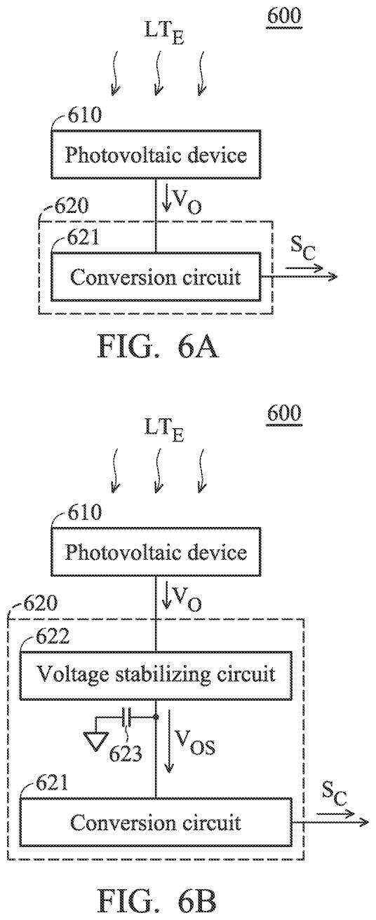

FIG. 6A is a schematic diagram of an exemplary embodiment of a driving device according to various aspects of the present disclosure. As shown in FIG. 6A, the driving device 600 comprises a photovoltaic device 610 and a control circuit 620. The photovoltaic device 610 can convert an external light LTE to generate an output voltage V_{O}. Since the feature of the photovoltaic device 610 is the same as the feature of the photovoltaic device 112 shown in FIG. 1, the description of the feature of the photovoltaic device 610 is omitted. The control circuit 620 comprises a conversion circuit 621. The conversion circuit 621 convers the output voltage V_{O} to generate a control signal Sc. In one embodiment, the conversion circuit 621 may be a digital-to-analog converter (DAC).

FIG. 6B is a schematic diagram of another exemplary embodiment of the driving device according to various aspects of the present disclosure. FIG. 6B is similar to FIG. 6A exception that the control circuit 620 of FIG. 6B further comprises a voltage stabilizing circuit 622. In such cases, the voltage stabilizing circuit 622 generate a steady voltage V_{OS} to the conversion circuit 621 according to the output voltage V_{O}. Therefore, when the output voltage V_{O} is changed temporarily, the control signal Sc is less affected. In one embodiment, the voltage stabilizing circuit 622 comprises a diode (not shown). In such cases, when the output voltage V_{O} is larger than the breakdown voltage of the diode, the diode maintains the steady voltage V_{OS} at a fixed value approximately. The kind of diode is not limited in the present disclosure. In one embodiment, the diode of the voltage stabilizing circuit 622 is a Zener diode.

In other embodiments, the control circuit 620 further comprises an energy storage element 623. The energy storage element 623 is charged with a steady voltage V_{OS}. When the output voltage V_{O} disappears suddenly, the conversion circuit 621 generates the control signal Sc according to the voltage stored in the energy storage element 623. In one embodiment, the energy storage element 623 is a capacitor, but the disclosure is not limited thereto.

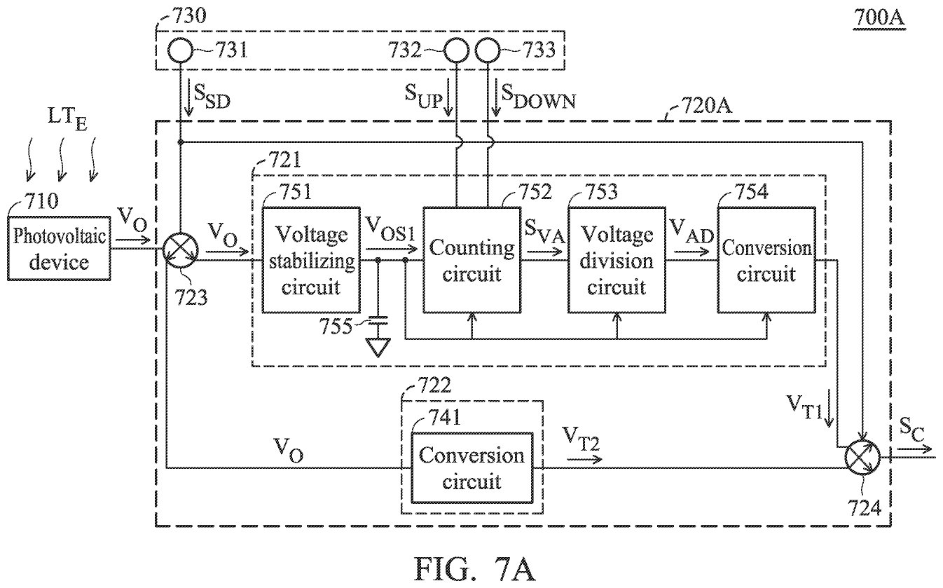

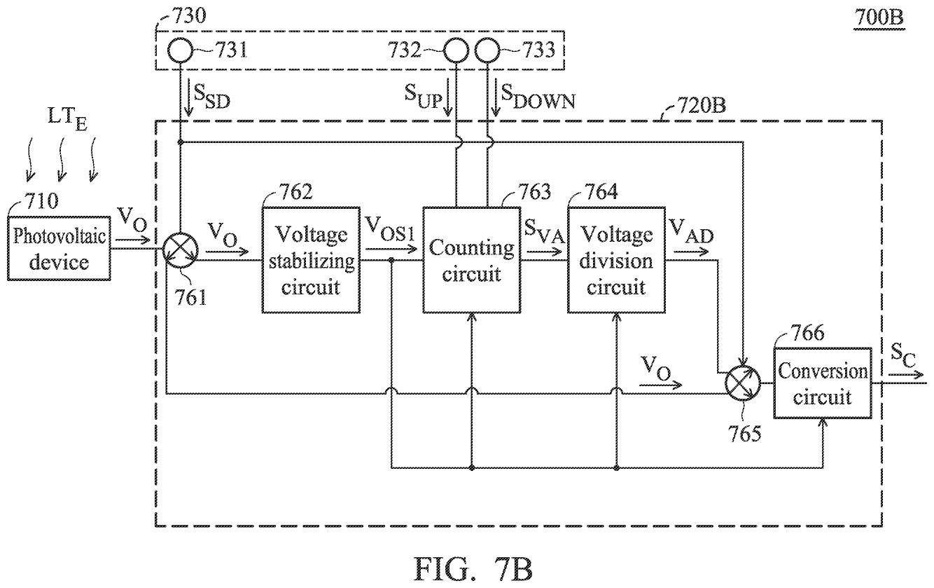

FIG. 7A is a schematic diagram of another exemplary embodiment of the driving device according to various aspects of the present disclosure. In this embodiment, the driving device 700A comprises a photovoltaic device 710, a control circuit 720A, and a sensing circuit 730. The photovoltaic device 710 generates an output voltage V_{O} according to the intensity of the external light LTE. Since the feature of the photovoltaic device 710 is the same as the feature of the photovoltaic device 112 of FIG. 1, the description of the feature of the photovoltaic device 710 is omitted.

The sensing circuit 730 comprises touch circuits 731˜733. When the user touches the touch circuit 731, it means that the user may want to switch the operation mode of the control circuit 720A. Therefore, the touch circuit 731 may enable a detection signal S_{SD}. In other embodiments, when the user touches the touch circuit 732, it means that the user may want to increase the transmittance of a liquid-crystal module (not shown). Therefore, the touch circuit 732 enables the detection signal S_{UP}. When the user touches the touch circuit 733, it means that the user may want to reduce the transmittance of a liquid-crystal module. Therefore, the touch circuit 733 enables the detection signal S_{DOWN}.

In this embodiment, the control circuit 720A comprises a manual module 721, an automatic module 722, and a selection circuits 723 and 724. The selection circuit 723 provides the output voltage V_{O} to the manual module 721 or the automatic module 722 according to the detection signal S_{SD}. For example, in an initial period, the selection circuit 723 provides the output voltage V_{O} to the automatic module 722. In such cases, the selection circuit 723 may serve the converted voltage V_{T2} generated by the automatic module 722 as the control signal Sc. when the detection signal S_{SD} is enabled, it may mean that the user wants to manually control the transmittance of a liquid-crystal module. Therefore, the selection circuit 723 provides the output voltage V_{O} to the manual module 721. At this time, the selection circuit 723 may not provide the output voltage V_{O} to the automatic module 722, and the selection circuit 724 may serve the converted voltage V_{T1} generated by the manual module 721 as the control signal Sc. In other embodiments, when the detection signal S_{SD} is enabled again, it may mean that the user wants the control circuit 720A to control the transmittance of the liquid-crystal module by itself. Therefore, the selection circuit 723 may provide the output voltage V_{O} to the automatic module 722. At this time, the selection circuit 723 may not provide the output voltage V_{O} to the manual module 721, and the selection circuit 724 may serve the converted voltage V_{T2} generated by the automatic module 722 as the control signal Sc. The structures of selection circuits 723 and 724 are not limited in the present disclosure. In one embodiment, the selection circuits 723 and 724 are multiplexers, but the disclosure is not limited thereto.

The automatic module 722 comprises a conversion circuit 741. The conversion circuit 741 converts the output voltage V_{O} to generate the converted voltage V_{T2}. Since the feature of the conversion circuit 741 is the same as the feature of the conversion circuit 621 of FIG. 6A, the description of the feature of the conversion circuit 741 is omitted. In other embodiments, the automatic module 722 may further comprise at least one of a voltage stabilizing circuit (not shown) and an energy storage element (not shown). Since the features of the voltage stabilizing circuit and the energy storage element are disclosed in FIG. 6B, the features of the voltage stabilizing circuit and the energy storage element is omitted.

The manual module 721 comprises a voltage stabilizing circuit 751, a counting circuit 752, a voltage division circuit 753 and a conversion circuit 754. The voltage stabilizing circuit 751 stabilizes the output voltage V_{O} to generate the steady voltage V_{OS1}. The voltage stabilizing circuit 751 provides the steady voltage V_{OS1} to the counting circuit 752, the voltage division circuit 753, and the conversion circuit 754. In such cases, the steady voltage V_{OS1} serves as the operation voltage of each of the counting circuit 752, the voltage division circuit 753, and the conversion circuit 754. After receiving the steady voltage V_{OS1}, each of the counting circuit 752, the voltage division circuit 753, and the conversion circuit 754 starts to operate. The structure of the voltage stabilizing circuit 751 is not limited in the present disclosure. Any circuit can serve as the voltage stabilizing circuit 751, as long as the circuit is capable of stabilizing voltage. In one embodiment, the voltage stabilizing circuit 751 is similar to the voltage stabilizing circuit 622 of FIG. 6B.

In this embodiment, the counting circuit 752 adjusts a counting value S_{VA} according to the detection signals S_{UP} and S_{DOWN} and outputs the counting value S_{VA}. In one embodiment, after receiving the steady voltage V_{OS1}, the counting circuit 752 resets the counting value S_{VA}. In such cases, when the detection signal S_{UP} is enabled, the counting circuit 752 increases the counting value S_{VA}. When the detection signal S_{DOWN} is enabled, the counting circuit 752 reduces the counting value S_{VA}. The structure of the counting circuit 752 is not limited in the present disclosure. Any circuit can serve as the counting circuit 752, as long as the circuit has a counting function.

The voltage division circuit 753 adjusts the steady voltage V_{OS1} according to the counting value S_{VA} to generate an adjustment voltage V_{AD}. The structure of the voltage division circuit 753 is not limited in the present disclosure. Any circuit can serve as the voltage division circuit 753, as long as the circuit is capable of adjusting voltages. The conversion circuit 754 converts the adjustment voltage V_{AD} to generate the converted voltage V_{T1}. In one embodiment, the conversion circuit 754 is similar to the conversion circuit 621 of FIG. 6A.

In other embodiments, the manual module 721 further comprises an energy storage element 755. The energy storage element 755 is charged with a steady voltage V_{OS1}. When the output voltage V_{O} disappears suddenly or is lower than a threshold value, the energy storage element 755 maintains the steady voltage V_{OS1} to maintain the operation of each of the counting circuit 752, the voltage division circuit 753, and the conversion circuit 754.

FIG. 7B is a schematic diagram of another exemplary embodiment of the driving device according to various aspects of the present disclosure. FIG. 7B is similar to FIG. 7A except for the control circuit 720B of FIG. 7B. In this embodiment, the control circuit 720B comprises selection circuits 761 and 765, a voltage stabilizing circuit 762, a counting circuit 763, a voltage division circuit 764, and a conversion circuit 766.

The selection circuit 761 provides the output voltage V_{O} to the voltage stabilizing circuit 762 or the selection circuit 765. For example, in an initial period, the selection circuit 761 may provide the output voltage V_{O} to the selection circuit 765. When the detection signal S_{SD} is enabled, the selection circuit 761 provides the output voltage V_{O} to the voltage stabilizing circuit 762. In such cases, when the detection signal S_{SD} is enabled again, the selection circuit 761 provides the output voltage V_{O} to the selection circuit 765. If the detection signal S_{SD} is enabled again, the selection circuit 761 provides the output voltage V_{O} to the voltage stabilizing circuit 762.

The voltage stabilizing circuit 762 stabilizes the output voltage V_{O} to generate the steady voltage V_{OS1} and provides the steady voltage V_{OS1} to the counting circuit 763, the voltage division circuit 764, and the conversion circuit 766. After receiving the steady voltage V_{OS1}, the counting circuit 763 adjusts the counting value S_{VA} according to the detection signal S_{UP} and S_{DOWN}. Furthermore, the voltage division circuit 764 adjusts the steady voltage V_{OS1} according to the counting value S_{VA} to generate the adjustment voltage V_{AD}. Since the features of the voltage stabilizing circuit 762, the counting circuit 763, and the voltage division circuit 764 are the same as the features of the voltage stabilizing circuit 751, the counting circuit 752, and the voltage division circuit 753 of FIG. 7A, the descriptions of the features of the voltage stabilizing circuit 762, the counting circuit 763, and the voltage division circuit 764 are omitted.

The selection circuit 756 provides the adjustment voltage V_{AD} or the output voltage V_{O} to the conversion circuit 766 according to the detection signal S_{SD}. For example, in an initial period, the selection circuit 765 provides the output voltage V_{O} to the conversion circuit 766. Therefore, the conversion circuit 766 operates in an automatic mode. In the automatic mode, the conversion circuit 766 converts the output voltage V_{O} to generate the control signal Sc. When the detection signal S_{SD} is enabled, the selection circuit 765 provides the adjustment voltage V_{AD} to the conversion circuit 766. At this time, the conversion circuit 766 operates in a manual mode. In the manual mode, the conversion circuit 766 converts the adjustment voltage V_{AD} to generate the control signal Sc. In such cases, when the detection signal S_{SD} is enabled again, the selection circuit 765 provides the output voltage V_{O} to the conversion circuit 766. Therefore, the conversion circuit 766 enters the automatic mode again. Since the feature of the conversion circuit 766 is the same as the feature of the conversion circuit 621 of FIG. 6A, the description of the feature of the conversion circuit 766 is omitted.

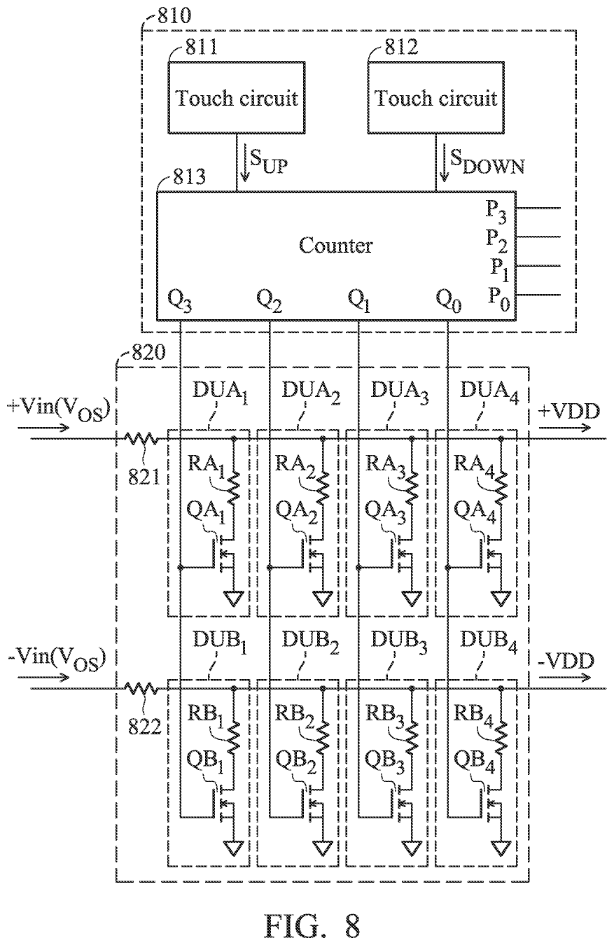

FIG. 8 is a schematic diagram of an exemplary embodiment of a countering circuit and a voltage division circuit according to various aspects of the present disclosure. In this embodiment, the counting circuit 810 comprises touch circuits 811 and 812 and a counter 813. The touch circuits 811 and 812 are configured to detect the touch actions from the user. When the user presses the touch circuit 811, the touch circuit 811 enables the detection signal S_{UP}. When the user presses the touch circuit 812, the touch circuit 812 enables the detection signal S_{DOWN}.

Since the operations of the touch circuits 811 and 812 are the same, the touch circuit 811 is provided as an example. When the user does not press the touch circuit 811, the detection signal S_{UP} maintains a first level, such as a high level or a low level. When the user presses the touch circuit 811, the touch circuit 811 enables the detection signal S_{UP}. Therefore, the detection signal S_{UP} is changed from the first level (e.g., a high level or a low level) to a second level (e.g., a low level or a high level). When the user stops pressing the touch circuit 811, the detection signal S_{UP} recovers from the second level to the first level.

The counter 813 comprises output terminals Q₃˜Q₀. The levels of the output terminals Q₃˜Q₀ constitute a counting value (e.g., the counting value S_{VA} of FIG. 7A). In this embodiment, the counter 813 adjusts the levels of the output terminals Q₃˜Q₀ according to the number of times that each of the detection signals S_{UP} and S_{DOWN} is changed from the first level to the second level. In other embodiments, the counter 813 comprises more or fewer output terminals. In another embodiment, the counter 813 further comprises input terminals P₃˜P₀ which are configured to receive an initial value. In such cases, the counter 813 adjusts the voltage levels of the output terminals Q₃˜Q₀ according to the voltage levels of the input terminals P₃˜P₀ to initial the transmittance of a liquid-crystal module.

The voltage division circuit 820 comprises resistors 821 and 822, voltage division units DUA₁˜DUA₄ and DUB₁˜DUB₄. One terminal of the resistor 821 receives the voltage +Vin, and the other terminal of the resistor 821 is coupled to the voltage division units DUA₁˜DUA₄. One terminal of the resistor 822 receives the voltage −Vin, and the other terminal of the resistor 822 is coupled to the voltage division units DUB₁˜DUB₄. In one embodiment, the level of the control signal Sc generated by the driving device is changed between a positive level and a negative level to increase the life of the liquid-crystal module. Therefore, the voltage stabilizing circuit (e.g., the voltage stabilizing circuit 751 of FIG. 7A) can generate two steady voltages V_{OS}. One of the two steady voltages V_{OS} is a positive voltage, and the other is a negative voltage. In such cases, the steady voltage V_{OS} with a positive level serves as the voltage +Vin, and the steady voltage V_{OS} with a negative level serves as the voltage −Vin.

The division units DUA₁˜DUA₄ are connected to each other in parallel. The division units DUA₁˜DUA₄ are coupled to the output terminals Q₃˜Q₀, respectively. The division units DUB₁˜DUB₄ are connected to each other in parallel. The division units DUA₁˜DUA₄ are coupled to the output terminals Q₃˜Q₀, respectively. The division units DUA₁˜DUA₄ process the voltage +Vin according to the levels of the output terminals Q₃˜Q₀. The division units DUB₁˜DUB₄ process the voltage −Vin according to the levels of the output terminals Q₃˜Q₀. For example, when the output terminal Q₃ is at a high level and each of the output terminals Q₂˜Q₀ is at a low level, the division units DUA₁ and DUB₁ are enabled and the division units DUA₂˜DUA₄ and DUB₂˜DUB₄ are not enabled. At this time, if the resistor 821 receives the voltage +Vin, the resistor 821 and the division unit DUA₁ divide the voltage +Vin to generate a first divided voltage. At this time, the first divided voltage serves as the voltage +VDD. Similarly, if the resistor 822 receives the voltage −Vin, the resistor 822 and the division unit DUB₁ divide the voltage −Vin to generate a second divided voltage. At this time, the second divided voltage serves as the voltage −VDD.

In this embodiment, each of the division units DUA₁˜DUA₄ and DUB₁˜DUB₄ comprises a resistor and a transistor. Taking the division unit DUA₁ as an example, the division unit DUA₁ comprises a resistor RA₁ and a transistor QA₁. The resistor RA₁ is coupled between the resistor 821 and the transistor QA₁. Since the structures of the division units DUA₁˜DUA₄ and DUB₁˜DUB₄ are the same, the descriptions of the structures of the division units DUA₂˜DUA₄ and DUB₁˜DUB₄ are omitted.

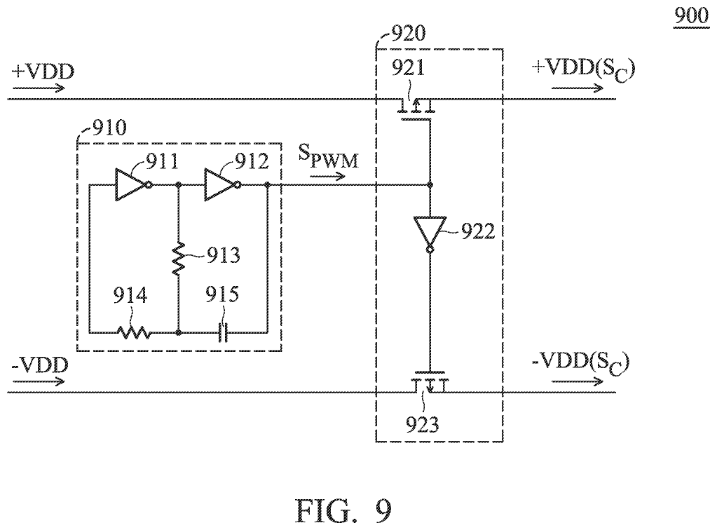

FIG. 9 is a schematic diagram of an exemplary embodiment of a conversion circuit according to various aspects of the present disclosure. The conversion circuit 900 comprises an oscillating module 910 and an inverting module 920. When the oscillating module 910 receives the electrical signal generated by a photovoltaic device, the oscillating module 910 generates an oscillation signal S_{PWM}. The circuit structure of the oscillating module 910 is not limited in the present disclosure. In one embodiment, the oscillating module 910 comprises inverters 911 and 912, resistors 913 and 914, and a capacitor 915.

The input terminal of the inverter 911 is coupled to one terminal of the resistor 914. The output terminal of the inverter 911 is coupled to the input terminal of the inverter 912 and one terminal of the resistor 913. The other terminal of the resistor 914 is coupled to the other terminal of the resistor 913. The capacitor 915 is coupled between the resistor 913 and the output terminal of the inverter 912. The output terminal of the inverter 912 is coupled to the inverting module 920 and outputs the oscillation signal S_{PWM}.

The inverting module 920 comprises transistors 921 and 923, and an inverter 922. The control terminal of the transistor 921 receives the oscillation signal S_{PWM}, the output terminal of the transistor 921 receives the voltage +VDD, and the output terminal of the transistor 921 is configured to output the voltage +VDD. For example, when the transistor 921 is turned on, the transistor 921 outputs the voltage +VDD. At this time, the voltage +VDD serves as the control signal Sc.

The input terminal of the inverter 922 is coupled to the control terminal of the transistor 921 and receives the oscillation signal S_{PWM}. The output terminal of the inverter 922 is coupled to the control terminal of the transistor 923. In this embodiment, when the transistor 921 is turned on, the transistor 923 is not turned. When the transistor 923 is turned on, the transistor 921 is not turned on.

The control terminal of the transistor 923 is coupled to the output terminal of the inverter 922, the input terminal of the transistor 923 receives the voltage −VDD, and the output terminal of the transistor 923 is configured to output voltage −VDD. For example, when the transistor 923 is turned on, the transistor 923 outputs the voltage −VDD. At this time, the voltage −VDD serves as the control signal Sc.

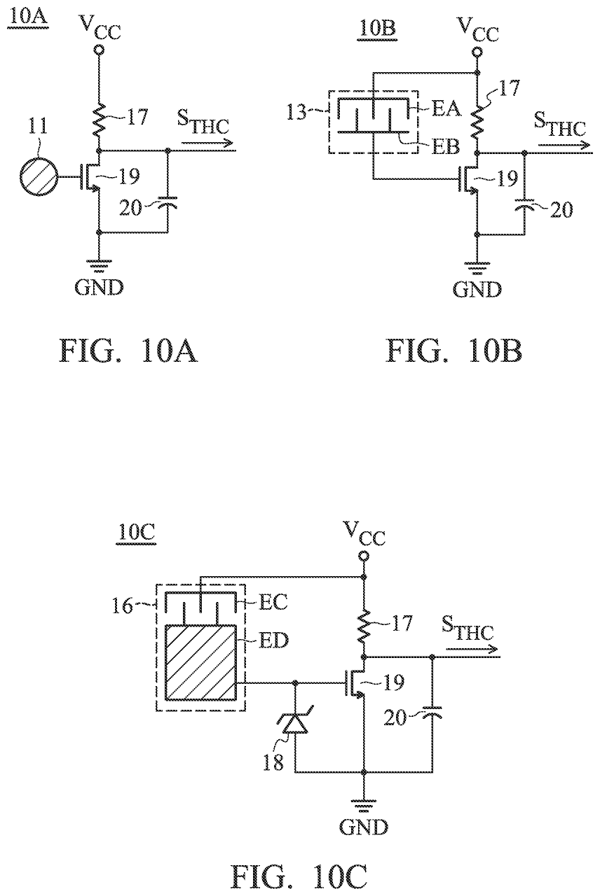

FIGS. 10A-10C are schematic diagrams of exemplary embodiments of a touch circuit according to various aspects of the present disclosure. In FIG. 10A, the touch circuit 10A comprises an electrode 11, a resistor 17, a transistor 19, and a capacitor 20. One terminal of the resistor 17 receives the voltage Vcc. The other terminal of the resistor 17 is coupled to the input terminal of the transistor 19 and the capacitor 20. The control terminal of the transistor 19 is coupled to the electrode 11. The output terminal of the transistor 19 is coupled to a ground node GND. The capacitor 20 is coupled between the input terminal of the transistor 19 and the ground node GND.

In this embodiment, when the user does not contact the electrode 11, the transistor 19 is turned off. Therefore, the detection signal S_{THC} is at a high level. When the user contacts the electrode 11, the transistor 19 is turned on. Therefore, the detection signal Sic is at a low level.

In FIG. 10B, the touch circuit 10B comprises an electrode 13, a resistor 17, a transistor 19, and a capacitor 20. The electrode 13 comprises a first part EA and a second part EB. The one terminal of the resistor 17 receives the voltage Vcc and is coupled to the first part EA. The other terminal of the resistor 17 us coupled to the input terminal of the transistor 19 and the capacitor 20. The control terminal of the transistor 19 is coupled to the second part EB. The output terminal of the transistor 19 is coupled to the ground node GND. The capacitor 20 is coupled between the input terminal of the transistor 19 and the ground node GND. In such cases, when the user contacts the electrode 13, the first part EA is short-circuited to the second part EB. Therefore, the transistor 19 is turned on. At this time, the detection signal Sic is at a low level. However, when the user does not contact the electrode 13, the first part EA is open-circuited from the second part EB. Therefore, the transistor 19 is not turned on. At this time, the detection signal Sic is at a high level.

In FIG. 10C, the touch circuit 10C comprises an electrode 16, a resistor 17, a diode 18, a transistor 19, and a capacitor 20. The electrode 16 has a first part EC and a second part ED. When the user contacts the electrode 16, the first part EC is short-circuited to the second part ED. When the user does not contact the electrode 16, the first part EC is open-circuited from the second part ED.

One terminal of the resistor 17 receives the voltage VCC and is coupled to the first part EC. The other terminal of the resistor 17 is coupled to the input terminal of the transistor 19 and the capacitor 20. The control terminal of the transistor 19 is coupled to the second part ED and the cathode of the diode 18. The output terminal of the transistor 19 is coupled to a ground node GND and the anode of the diode 18. The capacitor 20 is coupled between the input terminal of the transistor 19 and the ground node GND.

In this embodiment, when the user does not contacts the electrode 16, since the first part EC is open-circuited from the second part ED, the transistor 19 is not turned on. Therefore, the detection signal Sic is at a high level. When the user contacts the electrode 16, since the first part EC is short-circuited to the second part ED, the transistor 19 is turned on. Therefore, the detection signal S_{THC} is at a low level.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are used to distinguish one element from another.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A liquid-crystal device comprising:
a liquid-crystal module; and
a driving device providing a control signal to the liquid-crystal module to control transmittance of the liquid-crystal module and comprising:
a substrate;
a control circuit generating the control signal; and
a photovoltaic device supplying power to the control circuit,
wherein the control circuit and the photovoltaic device are located on the substrate.

2. The liquid-crystal device as claimed in claim 1, further comprising:
a sensing circuit formed on the substrate.

3. The liquid-crystal device as claimed in claim 1, wherein the control circuit comprises a plurality of transistors which are formed on the substrate.

4. The liquid-crystal device as claimed in claim 1, wherein the photovoltaic device comprises a plurality of thin-film photovoltaic elements, and the thin-film photovoltaic elements are formed on the control circuit.

5. The liquid-crystal device as claimed in claim 1, wherein the substrate is a flexible substrate or a transparent substrate.

6. A pair of sunglasses, comprising:
a liquid-crystal device comprising:
a liquid-crystal module; and
a driving device providing a control signal to the liquid-crystal module to control transmittance of the liquid-crystal module and comprising:
a substrate;
a control circuit generating the control signal; and
a photovoltaic device supplying power to the control circuit,
wherein the control circuit and the photovoltaic device are located on the substrate, and
a spectacle frame holding the liquid-crystal device.

7. The sunglasses as claimed in claim 6, further comprising:
a spectacle rim disposed between the liquid-crystal module and the spectacle frame and having a first side and a second side opposite to the first side,
wherein the liquid-crystal module is located in the first side of the spectacle rim, and the control circuit is located in the second side of the spectacle rim.

8. The sunglasses as claimed in claim 7, wherein the photovoltaic device is located on the spectacle frame.

9. The sunglasses as claimed in claim 6, wherein the driving device is located on the spectacle frame.

10. The sunglasses as claimed in claim 6, wherein the photovoltaic device detects the intensity of an external light to generate a detection result, and the control circuit controls the transmittance of the liquid-crystal module according to the detection result.

11. A liquid-crystal device, comprising:
a liquid-crystal module comprising a first substrate, a second substrate, and a liquid-crystal layer, wherein the liquid-crystal layer is enclosed between the first substrate and the second substrate;
a control circuit controlling transmittance of the liquid-crystal module; and
a photovoltaic device supplies power to the control circuit,
wherein the control circuit is disposed on one of the first substrate and the second substrate, and the photovoltaic device is disposed on one of the first substrate and the second substrate.

12. The liquid-crystal device as claimed in claim 11, wherein the control circuit is disposed on the first substrate, and the photovoltaic device is disposed on the second substrate.

13. The liquid-crystal device as claimed in claim 12, further comprising:
a sensing circuit formed by a thin-film process, wherein the sensing circuit and the photovoltaic device are disposed on the first substrate.

14. The liquid-crystal device as claimed in claim 12, further comprising:
a sensing circuit formed by a thin-film process, wherein the sensing circuit and the control circuit are disposed on the first substrate.

15. The liquid-crystal device as claimed in claim 11, wherein the photovoltaic device comprises a plurality of thin-film photovoltaic elements.

16. The liquid-crystal device as claimed in claim 11, further comprising:
a spectacle frame holding the liquid-crystal device.

17. The liquid-crystal device as claimed in claim 16, further comprising:
a spectacle rim disposed between the liquid-crystal module and the spectacle frame and having a first side and a second side opposite to the first side,
wherein the liquid-crystal module is located in the first side of the spectacle rim, and the control circuit is located in the second side of the spectacle rim.

18. The liquid-crystal device as claimed in claim 17, wherein the photovoltaic device is located on the spectacle frame.

19. The liquid-crystal device as claimed in claim 16, wherein the driving device is located on the spectacle frame.

20. The liquid-crystal device as claimed in claim 16, wherein the photovoltaic device detects the intensity of an external light to generate a detection result, and the control circuit controls the transmittance of the liquid-crystal module according to the detection
